(19) United States
(12) Patent Application Publication
(10) Pub. No.: US 2026/0018871 A1
(43) Pub. Date: Jan. 15, 2026

(54) LINEMAN TOOL

(71) Applicant: Hoosier Manufacturing Solutions LLC, Aurora, IN (US)

(72) Inventors: Colton William Keller, Lawrenceburg, IN (US); James David George, Aurora, IN (US); Jonathan Brian Smith, Deputy, IN (US)

(21) Appl. No.: 19/264,136

(22) Filed: Jul. 9, 2025

Related U.S. Application Data
(60) Provisional application No. 63/668,810, filed on Jul. 9, 2024.

(51) Int. Cl. H02G 1/12

(52) U.S. Cl. CPC H02G 1/1292

(57) ABSTRACT

A handheld tool for removing a distribution tie from a cable includes a body and a plurality of effector portions. The body includes a handle portion and a head portion. The plurality of effector portions are arranged on the head portion, each effector portion having a bight and a tooth.

### CROSS-REFERENCE TO RELATED APPLICATION

This application is related to and claims priority to U.S. Provisional Patent Application Ser. No. 63/668,810, filed Jul. 9, 2024, the entire contents of which are herein incorporated by reference.

### TECHNICAL FIELD

This invention relates to tools for removing a helical distribution tie wrapped around a conductor.

### BACKGROUND

Power lines supported on utility poles or towers are usually uninsulated. The line is well out of reach of the public and insulation both adds weight and retains heat that may be generated in the line as current passes through it. As shown in FIG. 2A, a power conductor line or cable 10 can be attached to an insulator 12 using a distribution grip or tie 14. The power line 10 rests in a top notch or channel 16 of the insulator 12. As is well-known in the field, on the insulator 12, the distribution tie 14 is wrapped over the line 10, around an annular groove 18 of the insulator 12, and then helically around opposite extensions of the line 10 on either side of the insulator 12. The distribution tie 14 is a stiff wire or group of stiff wires, usually aluminum-covered steel, with each end portion or segment 20 pre-formed into a helix that terminates at a free end 24. The steel is tempered to be stiff, but to allow some degree of forced spring resilience. In another use, a distribution tie dead-end 22 can be used to secure a cable 10 to a pole or building (not shown) where the line 10 is supported and then continues to a termination that is not in tension. As shown in FIG. 2B, a dead-end tie 22 or grip is used where the power line 10 is held in tension on only one side of an attachment point 13 near the insulator 12 and the other side is allowed to be slack. The dead-end tie 22 has a loop attachment to the attachment point 13 near the insulator 12, with both end portions or segments 20 of the tie 22 helically wrapped around the same length/segment of the cable 10 together in the same direction (i.e., in parallel helices).

The stiff, pre-formed helix is easily wrapped around the cable 10 by hand, starting at a position proximal its middle and working toward its free end 24. The stiffness of the distribution tie material facilitates installation and its staying in place once installed.

If the distribution tie 14, 22 needs to be removed or replaced, the stiff, helically arranged end portions 20 wrapped about the cable 10 must be unwound. Linemen are often left to use their hands, or a tool not meant for the application (such as a knife, a screwdriver, pliers, etc.) to pry at the end portions 20 of the distribution ties 14, 22, posing a risk of injury to the person or damage to the conductor or the tools. There remains a need for a specialized tool to assist in removal of a distribution tie 14, 22 to improve lineman safety and protect power lines from damage in power-line repair or maintenance applications.

### SUMMARY OF THE INVENTION

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a handheld tool for removing a distribution tie from a cable may include a body and a plurality of effector portions. The body may include a handle portion and a head portion. The plurality of effector portions may be arranged on the head portion, with each effector portion having a bight and a tooth.

According to an embodiment consistent with the present disclosure, a handheld tool for removing a distribution tie from a cable may include a body and a plurality of effector portions. The body may include a handle portion and a head portion. The plurality of effector portions may be arranged on the head portion, with each effector portion having a bight and a tooth, wherein the bight includes a semi-circular portion defined by a radius that is substantially equal to a radius of a cross-section of the cable, and the teeth are oriented generally parallel to an axis of the cable.

According to yet an embodiment consistent with the present disclosure, a handheld tool for removing a distribution tie from a cable may include a body and a plurality of effector portions. The body may include a handle portion and a head portion. The plurality of effector portions may be arranged on the head portion, with each effector portion having a bight and a tooth. The bights may include a semi-circular portion and a ramp portion leading into the semi-circular portion, the semi-circular portion being defined by a radius that is substantially equal to a radius of a cross-section of the cable. The teeth may be oriented generally parallel to an axis of the cable. At least two of the end effector portions may be configured for use with cables having different gauges. The body may include a first side and a second side, with some of the effector portions provided on the first side of the body and with other ones of the effector portions provided on the second side of the body.

Other aspects, features, benefits, and advantages of the present invention will become apparent to a person of skill in the art from the detailed description of various embodiments with reference to the accompanying drawing figures, all of which comprise part of the disclosure.

### BRIEF DESCRIPTION OF THE DRAWINGS

Like reference numerals are used to indicate like parts throughout the various drawing figures, wherein:

FIG. 1 is a lineman tool according to one embodiment of the present invention;

FIG. 2A is a pictorial view of a power conductor supported by an insulator and secured thereto by a distribution tie;

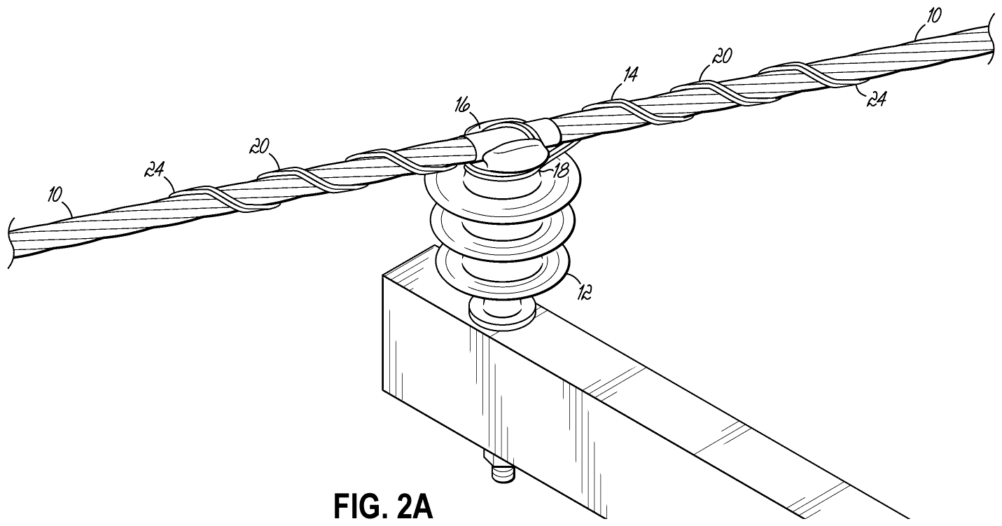

FIG. 2B is a pictorial view of a power conductor supported by a dead-end distribution tie attached to an insulator;

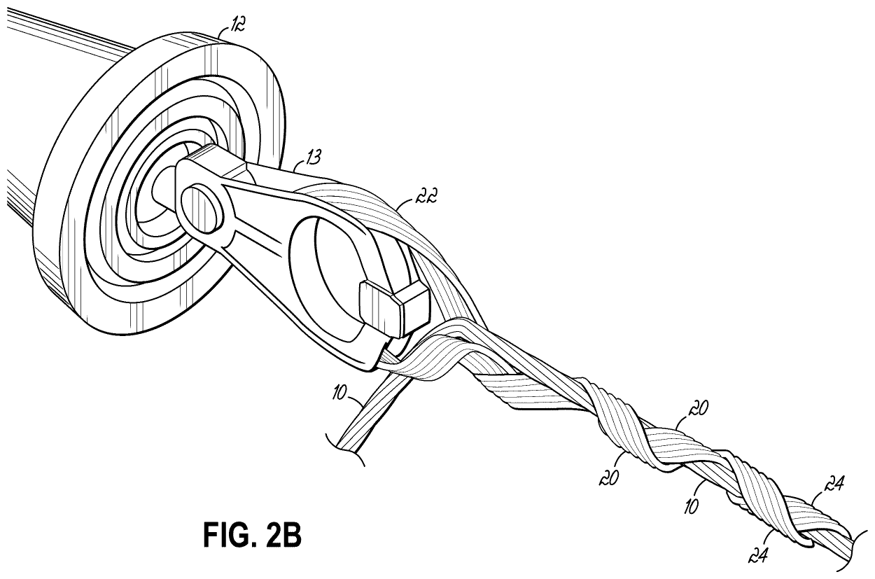

FIG. 3 is a first pictorial view of the tool being placed against a power conductor line to displace the end of a distribution tie;

FIG. 4 is a second pictorial view showing the tool being rotated against the end of the distribution tie;

FIG. 5 is a third pictorial view showing the tool fully rotated to displace the end of the distribution tie;

FIG. 6 is another pictorial view of the tool being placed against a power conductor line to displace the end of a distribution tie showing the tool being rotated against the end of the distribution tie using a different effector head portion;

FIG. 7 is a pictorial view showing the tool fully rotated to displace the end of the distribution tie; and

FIG. 8 is another embodiment of a lineman tool according to one or more other embodiments of the present disclosure.

### DETAILED DESCRIPTION

With reference to the drawing figures, this section describes particular embodiments and their detailed construction and operation. Throughout the specification, reference to “one embodiment,” “an embodiment,” or “some embodiments” means that a particular described feature, structure, or characteristic may be included in at least one embodiment. Thus, appearances of the phrases “in one embodiment,” “in an embodiment,” or “in some embodiments” in various places throughout this specification are not necessarily all referring to the same embodiment. Furthermore, the described features, structures, and characteristics may be combined in any suitable manner in one or more embodiments. In view of the disclosure herein, those skilled in the art will recognize that the various embodiments can be practiced without one or more of the specific details or with other methods, components, materials, or the like. In some instances, well-known structures, materials, or operations are not shown or not described in detail to avoid obscuring aspects of the embodiments. “Proximal” will indicate a direction toward where a tool is gripped by a user, while “distal” will indicate the opposite direction. “Lateral” or “transverse” indicates a side-to-side direction generally perpendicular to the midline of the handheld tool. As used herein, “power line,” “line,” “conductor,” or “cable” are used interchangeably.

The present disclosure is directed towards a handheld tool and a method of using the tool to remove a distribution tie from a power line or cable.

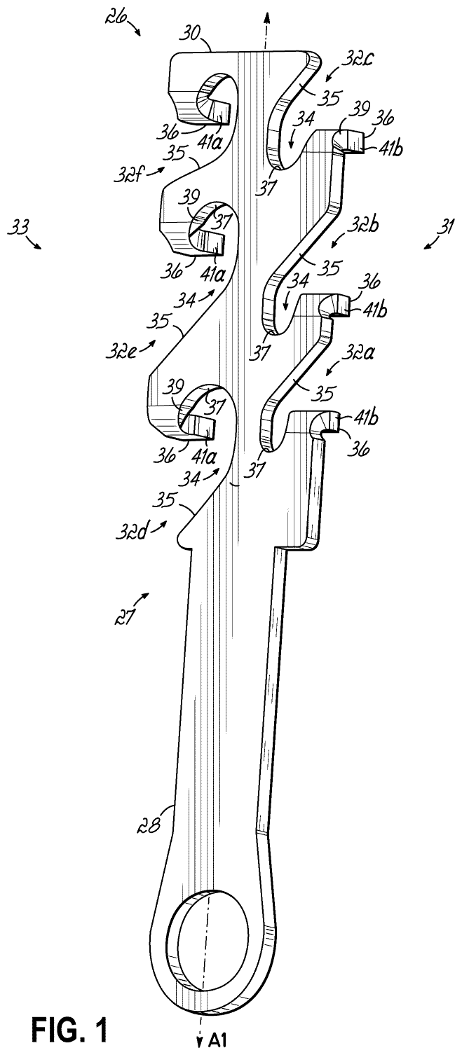

FIG. 1 depicts a tool 26 for removing a distribution tie 14, 22 from a power line or cable 10, according to one or more embodiments. In the illustrated embodiment, the tool 26 includes a body 27 extending along an axis A1, a handle portion 28, and a head portion 30. The body 27 includes a front face 29 and a rear face (obscured from view) opposite the front face 29, as well as a first side 31 and a second side 33 opposite the first side 31. Here, the handle portion 28 is arranged at a lower end of the body 27 and extends into the head portion 30. As shown, the tool 26 also includes one or more effector portions or effector head portions 32a-f provided on the head portion 30. The illustrated embodiment includes six effector head locations or portions 32 a-f, each configured for use on a different gauge/size/diameter of power line or cable 10. However, more or less than six of the effector head portions 32a-f may be included in other embodiments. Also in the illustrated embodiment, the effector head portions 32a-f are equally distributed between the first and second sides 31, 33, three of the effector head portions 32a-c provided on the first side 31 and the other three effector head portions 32d-f provided on the second side 33. However, they may be unequally distributed between the sides 31, 33, such that one of the sides has more effector head portions 32a-f than the other side.

Each effector head portion 32 includes a notch or bight 34 and a tooth 36 arranged adjacent to the bight 34. As shown, the tooth 36 laterally protrudes from the body 27. The tooth 36 includes a top wall 61, a bottom wall 63 opposite the top wall 61, and a pair of sidewalls 41a, 41b in between the top and bottom walls 61, 63. The bight portion 34 of each effector head location 32 is sized to receive the power line 10 adjacent the free end 24 of the helically arranged end portion/segment 20 of a distribution tie 14 wrapped around the line 10. The bight 34 can be inset into or formed within the head portion 30 at an angle (as shown and relative to the axis A1) such that the tooth 36 aligns with the axial center of the power line 10 when engaged. For example, when the tool 26 is placed on the power line 10, the bight 34 will be aligned with an axis A2 of the power line 10, wherein the axis A2 extends through the axial center of any cross-section of the power line 10.

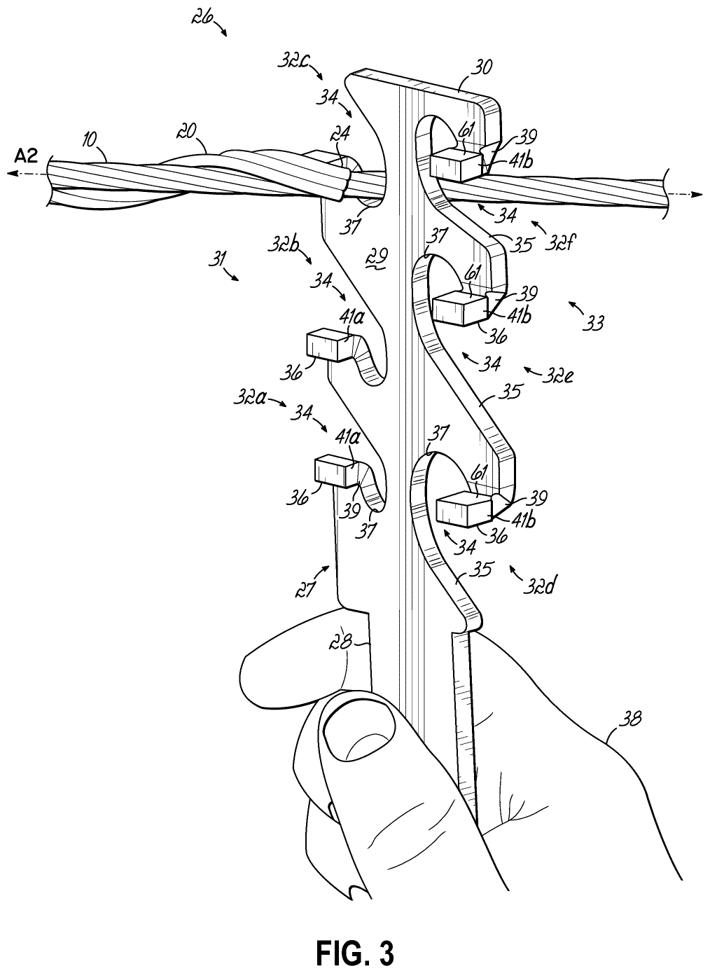

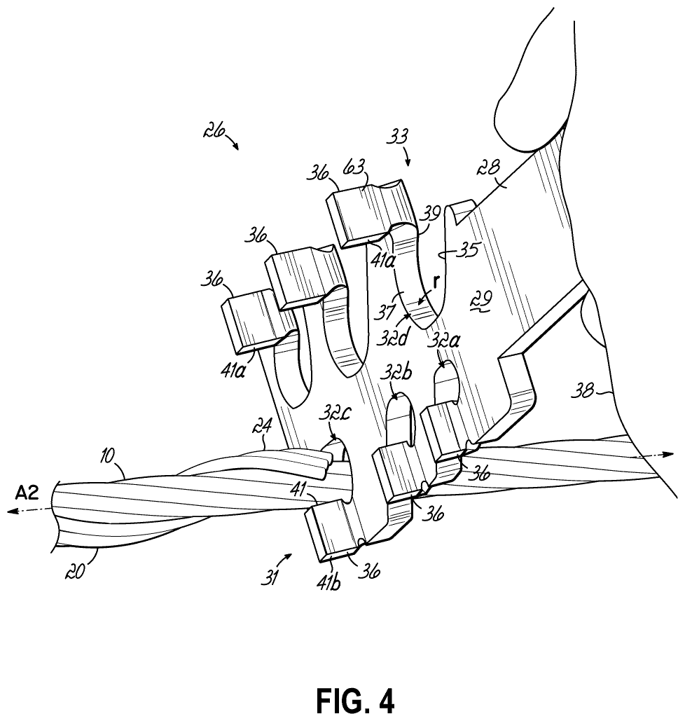

The tooth 36 extends and protrudes from a face 29 of the body 27. In the illustrated embodiment, the tooth 36 of each effector head location 32 extends in a direction that, when the tool 26 is operably placed in engagement with the power line 10, is substantially parallel to the axis A2 of the power line 10. Also, the tooth 36 is positioned to engage or abut an edge of the free end 24 of the distribution tie 14 so that rotation of the tool 26, about the axis A2 of the power line 10 (that extends through the axial center of the power line 10 as shown in FIGS. 3-4), displaces the free end 24 of the stiff distribution tie 14 from the power line 10, unwinding the helically shaped end portion/segment 20 it in a direction opposite of its helical form. Once the free end 24 of the distribution tie 14 is displaced from engagement on the cable 10, it can easily be unwound the rest of the way by hand. Thus, the tooth 36 may extend in a direction generally parallel to the axis A2 of the cable 10, and the tooth 36 may be positioned at an end 39 of the notch 34 such that, when the cable 10 is positioned in the notch 34, an inner sidewall 41a of the tooth 36 extends next to the cable 10.

In the illustrated embodiment, the bight 34 includes a ramp portion 35 and a curved or semi-circular portion 37, wherein the ramp portion 35 leads or extends into the semi-circular portion 37. The semi-circular portion 37 may also be referred to as a curved or arced portion. The power line 10, when evaluated in cross-section, has a circular shape (i.e., a circular cross-sectional shape), and the semi-circular portion 37 of the bight 34 conforms in shape with circular cross-sectional shape of the power line 10. Thus, the semi-circular portion 37 of the bight 34 is defined by a radius r that is substantially similar or equal to a radius of the power line 10 (i.e., the radius defining the semi-circular portion 37 is substantially similar to or equal to the radius of the cross-sectional shape of the power line 10). In embodiments, the radius r is a constant radius, however, in some embodiments, the radius r defining the semi-circular portion 37 may vary (increase or decrease) along the perimeter surface of the bight 34, for example, as the bight 34 transitions into the flat, straight, or ramp portions 35 of effector head portion 32. The tooth 36 extends from an end 39 of the semi-circular portion 37 (or from an end of a straight portion leading from the semi-circular portion 37) in a direction that is substantially parallel to the axis A2 of the power line 10. In embodiments, the notch 34 includes a transition portion (i.e., that is straight, angled, or less-curved than the semi-circular portion 37) that extends between the semi-circular portion 37 and the tooth 36, with the end 39 being an end of the transition portion, such that the the tooth 36 extends from an end 39 of the transition portion. By including this transition portion in between the semi-circular portion 37 and the tooth 36, it is possible to further adjust the position at which the tooth 36 extends relative to the cable 10.

When using the tool 26 to engage the distribution tie 14 on the power line 10, the operator will position the tool 26 such that one of the bights 34 is in close proximity to the power line 10, and then move the ramp portion 35 into contact with the power line 10 and over the power line 10, such that the power line 10 slides on (and is guided by) the surface of the ramp portion 35 into the semi-circular portion 37 of the bight 34. In the illustrated embodiment, the bights 34 of each of the effector head portions 32a-f has a different size that corresponds to a different gauge of the power line 10. Thus, the semi-circular portion 37 in the bight 34 of the first effector head portion 32a may be larger than the semi-circular portion 37 of the second effector head portion 32b, the semi-circular portion 37 in the bight 34 of the second effector head portion 32b may be larger than the semi-circular portion 37 of the third effector head portion 32c, and so on. In this manner, the tool 26 is utilizable with differently gauged/sized power lines 10, with the first end effector head portion 32a being configured for use with a power line having a first gauge and the second end effector head portion 32b being configured for use with a power line having a second gauge that is smaller than the first gauge, and so on. However, one or more of the semi-circular portions 37 of any of the end effector portion 32a-f may have the same radius r such that they are configured for use with the same gauge of power line. To displace the free ends 24 from the cable 10 using the tool 26, the user rotates the tool 26 relative to the cable 10, generally around the axis A2 of the cable 10, such that one of the sidewalls 41a, 41b, and/or one of the top or bottom walls 61, 63 of the tooth 36 will come into contact with and then push against the free end 24 of the distribution tie 14, thereby displacing the free end 24 it in a direction opposite its helical form and in a direction outward and away from the axis A2 of the cable 10.

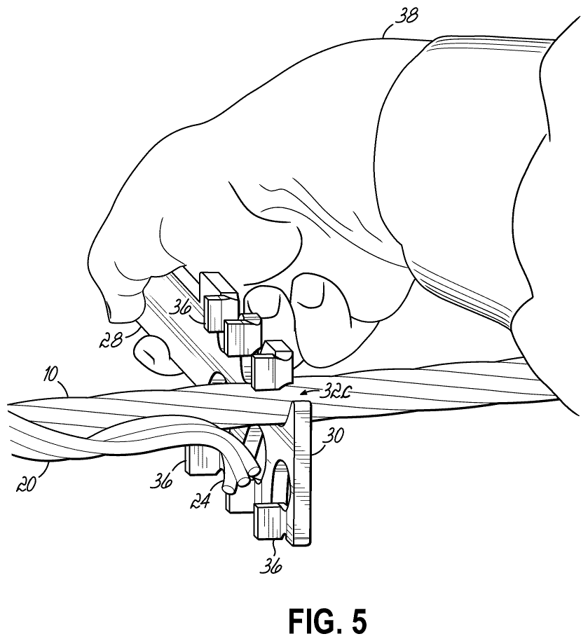

FIGS. 3-5 show sequentially a method of using the tool 26 of the present invention, according to embodiments. As shown in FIG. 3, the handle portion 28 of the tool can be gripped with the user's hand 38 and a selected effector head portion 32c having a bight 34 sized to correspond to the gauge (diameter) of the cable 10 is placed on the cable 10 adjacent to the free end 24 of the installed distribution tie 14. The tooth 36 is positioned to abut the end portion 24 of the distribution tie 14. As shown in FIG. 4, when the user rotates the tool 26 relative to the cable 10, generally around the axis A2 of the cable 10), the sidewall 41a and/or the bottom wall 63 of the tooth 36 (of the selected effector head portion 32c) will come into contact with and then push against the free end 24 of the distribution tie 14, thereby displacing the free end 24 it in a direction opposite its helical form and in a direction outward and away from the axis A2 of the cable 10. Referring to FIG. 5, once the free end 24 of the distribution tie 14 is disengaged from the cable 10, the distribution tie 14 is easily removed by hand.

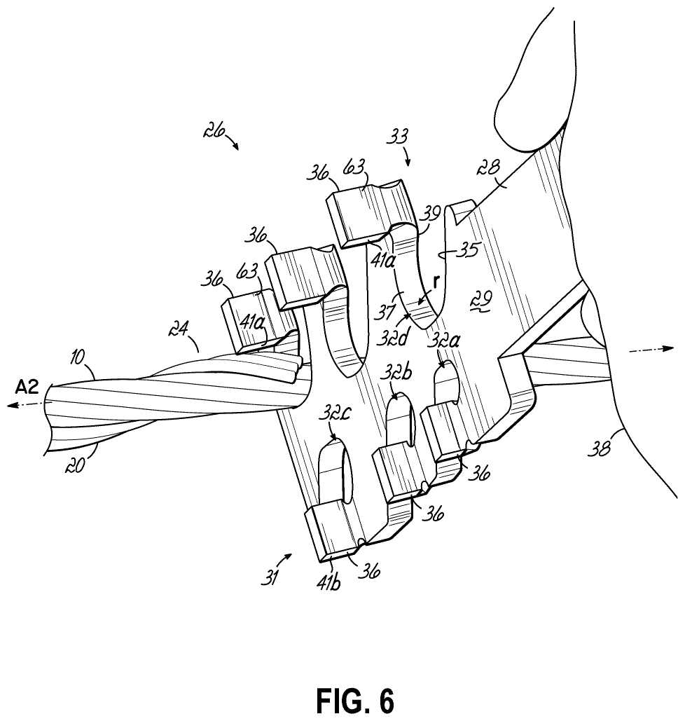

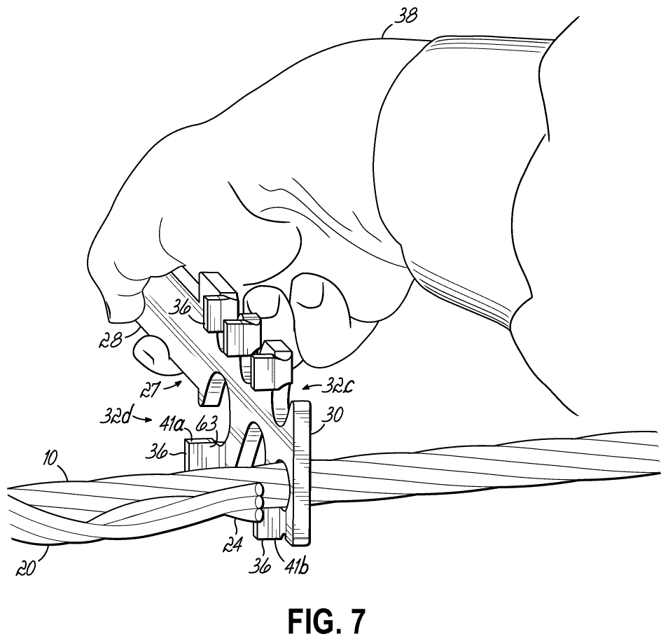

Note that in the illustrated embodiments, each of the teeth 36 includes a pair of the opposing sidewalls 41a, 41b and opposing top and bottom sides 61, 63 that may be rotated into contact with the free ends 24 to thereby displace and unwind the free end 24 from the cable 10. The particular one of the sides 41a, 41b, 61, 63 of the tooth 36 that will engage the free end 24 will depend on the direction that the tool 26 is rotated about the cable 10 and which of the effector head portions 32 is being utilized, as well as the location of the tooth 36 relative to the curvature 37 of the notch 34 within which the cable 10 extends. Thus, while FIGS. 3-5 depict an example method of using the tool 26 when the cable 10 is positioned in the effector head portion 32c, the cable 10 may instead be positioned in another one of the effector head portions 32a,b,d,e,f. For example, a differently gauged cable 10 may be positioned in effector head portion 32f as shown in FIGS. 6-7, which also show sequentially a method of using the tool 26 of the present invention, according to embodiments. In this example, the tool 26 is hung on the cable 10, with the cable 10 being positioned in the notch 34 of effector head portion 32f. Here, rotation of the tool 26 in the illustrated direction results in the side surface 41a and/or the top surface 61 contacting and thereby displacing the free end 24 of the segment 20.

In the illustrated embodiment, the tooth 36 of each effector head portion 32 each extends from the same side of the tool body 27, for example, to the left from the surface 29 as pictured in FIGS. 3-7. In this manner, the effector head portions 32a-c on one side 31 are used by engaging the cable 10 in the bight 34 from the front side of the cable 10 (as shown in FIGS. 3-7) and the effector head portions 32d-f on the opposite side 33 of the head portion 30 are used by engaging the cable 10 in the bight 34 from the back side of the cable 10 (not illustrated). In an alternate embodiment (not shown), the teeth 36 on one side (e.g., the second side 33) of the tool 26 can extend in the opposite direction (that is parallel to the axis A2) as compared to the teeth 36 on the other side (e.g., the first side 31) so the tool 26 is flipped over in the user's hand 38 to use the other set of effector head portions 32, also from the front side of the cable 10. Thus, the all of the teeth 36 can extend/protrude from the front face 29 of the body 27 in a direction that is substantially parallel to the axis A2 of the cable 10 or, in other embodiments, some teeth 36 can extend from the front face 29 in a direction that is substantially parallel to the axis A2 and other teeth 36 can extend from the rear face (obstructed from view) in a direction that is substantially parallel to the axis A2 of the cable 10.

The tool 26 can be made of a rigid, lightweight metal, such as an aluminum alloy, or may be made of a sturdy polymer or fiber reinforced resin material. The tool 26 can be made to accommodate multiple cable gauges, as shown in the illustrated embodiment, or it can be made to fit only a single gauge most routinely encountered by a particular lineman (not illustrated).

It should also be noted that, while the tool 26 is configured for use with a distribution grip or tie 14 having end portions/segments 20 that helically wrap around the cable 10 in a first (or right-handed) wrapping or winding direction, in another embodiment, the tool 26 is configured as a mirror-image of the tool depicted in FIGS. 1 and 3-7 so that it is utilizable where the end portions/segments 20 of the distribution grip or tie 14 wind/wrap around the cable 10 in an opposite (or left handed) wrapping or winding direction.

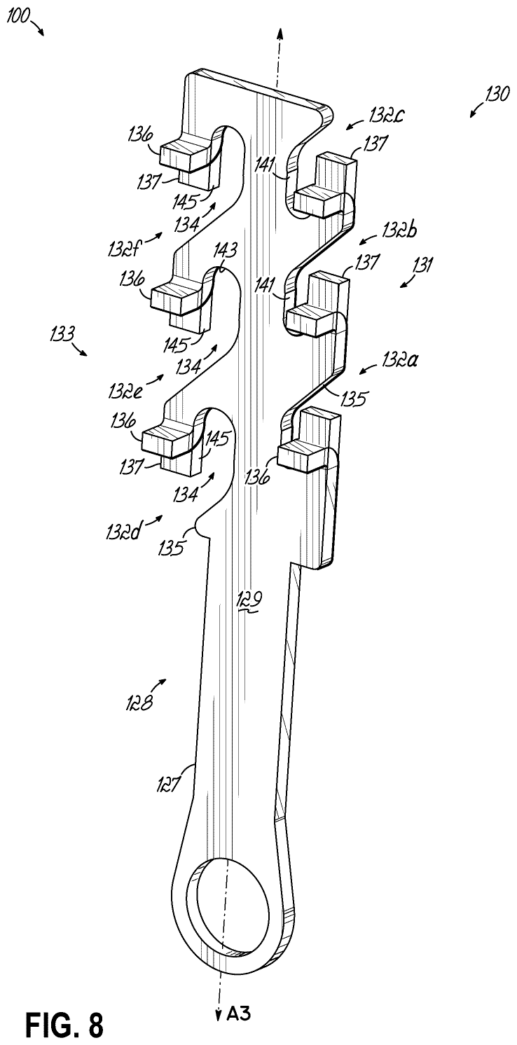

FIG. 8 depicts another embodiment of a tool 100 for removing a distribution tie 14, 22 from a power line or cable 10, according to one or more embodiments. The tool 100 is similar to the tool 26 described above, and thus includes a body 127 extending along an axis A3, a handle portion 128, and a head portion 130. The handle portion 128 extends towards a lower end of the body 127 and the head portion 128 extends towards an upper end of the body, wherein the upper end is opposite the lower end. The body 27 includes a front face 129 and a rear face (obscured from view) opposite the front face 129, as well as a first side 131 and a second side 133 opposite the first side 131. The tool 100 also includes one or more effector portions or effector head portions 132a-f provided on the head portion 130.

Each effector head portion 132 includes a notch or bight 134 and a tooth 136 arranged adjacent to the bight 134. As shown, the tooth 36 extends/protrudes outward from the front face 129 of the body 27. In embodiments, one or more of the teeth may also extend from the rear face of the body 27. In an embodiment, the tooth associated with any one or more of the effector head portions 132 has a front tooth portion extending from the front face 129 and a rear tooth portion extending from the rear face.

Also in the illustrated embodiment, each of the effector head portions 132 includes an extension portion 137 that extends beyond the associated tooth 136. Here, each extension portion 137 extends substantially parallel to the axis A3, with the extension portions 137 associated with the effector head portions a-c extending upward towards the upper end of the body 127, and with the extension portions 137 associated with the effector head portions 132d-f extending downward towards the lower end of the body 127 (i.e., towards the handle portion 128). Due to the presence of the extension portion 137, the tooth 136 extends from the face 129 with a portion of the body 127 being present above and beneath the tooth 136, such that a portion of the face 127 is present above and beneath the tooth 136. Thus, rather than the tooth 36 extending from an end 39 of the bight 34 (i.e., at an end of the semi-circular portion 37) as with the tool 26 detailed above, the tooth 136 extends from a location on the face 129 of the body 127 such that is not at the end of the bight 134, such that the extension portion 137 is positioned above or beneath the tooth 136 (depending whether the tooth 136 is associated with effector head portions 132a-c or effector head portions 132d-f) and the semi-circular portion 143 is positioned beneath or above the tooth 136.

Each of the bights 134 is substantially U-shaped, having a first straight portion 141 defined by a central portion of the body 127, semi-circular portion 143, and a second straight portion 145 defined by the side of the tooth 136 and the side of the extension portion 137. The opening of the U-shaped bights 134 may be narrowed by an angled portion or ramp portion 135.

While one or more embodiments of the present invention have been described in detail, it should be apparent that modifications and variations thereto are possible, all of which fall within the true spirit and scope of the invention. Therefore, the foregoing is intended only to be illustrative of the principles of the invention. Further, since numerous modifications and changes will readily occur to those skilled in the art, it is not intended to limit the invention to the exact construction and operation shown and described. Accordingly, all suitable modifications and equivalents may be included and considered to fall within the scope of the invention, defined by the following claim or claims.

What is claimed is:

1. A handheld tool for removing a distribution tie from a cable, comprising:
a body having a handle portion and a head portion; and
a plurality of effector portions arranged on the head portion, each effector portion having a bight and a tooth.

2. The handheld tool of claim 1, wherein the bight portion includes a ramp portion and a semi-circular portion, the ramp portion leading into the ramp and being oriented at an angle relative to an axis of the body.

3. The handheld tool of claim 2, wherein the semi-circular portion is defined by a radius.

4. The handheld tool of claim 3, wherein the radius of the semi-circular portion is substantially equal to a radius of the cable when evaluated in cross-section.

5. The handheld tool of claim 4, wherein the tooth extends in a direction that is substantially parallel to an axis of the cable.

6. The handheld tool of claim 1, wherein each of the end effector portions is configured for use with cables having different gauges.

7. The handheld tool of claim 1, wherein at least two of the end effector portions are configured for use with cables having a same gauge.

8. The handheld tool of claim 1, wherein the body includes a first side and a second side, and the plurality of effector portions are equally distributed on the first side and the second side.

9. The handheld tool of claim 1, wherein the body includes a front face and a rear face, and the teeth of all of the effector portions all protrude from the front face.

10. The handheld tool of claim 9, wherein the teeth extend from the front face in a direction that is substantially parallel to an axis of the cable.

11. The handheld tool of claim 1, wherein the body includes a front face and a rear face, and the teeth of some of the effector portions protrude from the front face, and the teeth of other ones of the effector portions protrude from the rear face.

12. The handheld tool of claim 11, wherein the teeth extend from the front face and the rear face in directions that are substantially parallel to an axis of the cable.

13. A handheld tool for removing a distribution tie from a cable, comprising:
a body having a handle portion and a head portion; and
a plurality of effector portions arranged on the head portion, each effector portion having a bight and a tooth, wherein the bight includes a semi-circular portion defined by a radius that is substantially equal to a radius of a cross-section of the cable, and the teeth are oriented generally parallel to an axis of the cable.

14. The handheld tool of claim 13, wherein the bight portion includes a ramp portion leading into the semi-circular portion, wherein the ramp portion is oriented at an angle relative to an axis of the body.

15. The handheld tool of claim 13, wherein each of the end effector portions is configured for use with cables having different gauges.

16. The handheld tool of claim 13, wherein at least two of the end effector portions are configured for use with cables having a same gauge.

17. The handheld tool of claim 13, wherein the body includes a first side and a second side, and the plurality of effector portions are equally distributed on the first side and the second side.

18. The handheld tool of claim 13, wherein the body includes a front face and a rear face, and the teeth of all of the effector portions all protrude from the front face.

19. The handheld tool of claim 13, wherein the body includes a front face and a rear face, and the teeth of some of the effector portions protrude from the front face, and the teeth of other ones of the effector portions protrude from the rear face.

20. A handheld tool for removing a distribution tie from a cable, comprising:
a body having a handle portion and a head portion; and
a plurality of effector portions arranged on the head portion, each effector portion having a bight and a tooth; wherein:
the bight includes semi-circular portion and a ramp portion leading into the semi-circular portion, the semi-circular portion being defined by a radius that is substantially equal to a radius of a cross-section of the cable;
the teeth are oriented generally parallel to an axis of the cable;
at least two of the end effector portions are configured for use with cables having different gauges; and
the body includes a first side and a second side, with some of the effector portions provided on the first side of the body and with other ones of the effector portions provided on the second side of the body.
